(19) United States
(12) Patent Application Publication
(10) Pub. No.: US 2011/0023088 A1
(43) Pub. Date: Jan. 27, 2011

(54) FLOW-BASED DYNAMIC ACCESS CONTROL SYSTEM AND METHOD

(75) Inventors: Nam-Seok KO, Daejeon (KR); Soon-Seok Lee, Daejeon (KR); Jong-Dae Park, Daejeon (KR); Sung-Kee Noh, Daejeon (KR); Pyung-Koo Park, Daejeon (KR); Seung-Woo Hong, Daejeon (KR); Sung-Back Hong, Daejeon (KR); Seong Moon, Daejeon (KR)

Correspondence Address: AMPACC Law Group, PLLC, 6100 219th Street SW, Suite 580, Mountlake Terrace, WA, 98043, US

(73) Assignee: Electronics and Telecommunications Research Institute, Daejeon (KR)

(21) Appl. No.: 12/842,194

(22) Filed: Jul. 23, 2010

(30) Foreign Application Priority Data
Jul. 23, 2009 (KR) 10-2009-0067516
May 7, 2010 (KR) 10-2010-0043223

(51) Int. Cl. G06F 21/20

(52) U.S. Cl. 726/3; 726/22

(57) ABSTRACT

A traffic analysis and flow-based dynamic access control system and method. The flow-based dynamic access control system for controlling a user's access to an internal communication network through an external communication network includes an access control unit operating in an access control mode in which traffic received from a user is basically blocked, generating state management information of a flow, which is received from the user, based on a specified packet of the flow, and verifying whether access of the flow to the internal communication network is a normal access. As a proactive defense concept of allowing only normal users to access an internal network, a method of blocking attacks from a system contaminated by a worm virus, detecting a cyber attack on a certain system in advance and automatically avoiding the cyber attack, and guaranteeing the quality of normal traffic even under cyber attacks without performance degradation of the internal network is provided.

### CROSS-REFERENCE TO RELATED APPLICATION

This application claims the benefit under 35 U.S.C. §119(a) of Korean Patent Application Nos. 10-2009-0067516, filed on Jul. 23, 2009, and 10-2010-0043223, filed on May 7, 2010, the entire disclosures of which are incorporated herein by references for all purposes.

### BACKGROUND

1. Field

The following description relates to a system and method for protecting a network from cyber attacks and guaranteeing the quality of normal traffic even under the cyber attacks.

2. Description of the Related Art

A denial-of-service (DoS) attack typically involves traffic flooding to a target network is node, such as a website, an Internet service provider (ISP), or a server with a huge amount of traffic beyond its processing capacity thus rendering the target network node inoperable for the duration of the attack.

A more sophisticated attack is a distributed DoS (DDoS) attack. In a DDoS attack, an attacker subverts a number of network nodes by exploiting well-known security loopholes. These compromised network nodes essentially become slaves of the attacker and act as launch points to inject traffic into a network. By summoning a reasonable number of compromised nodes, an attacker can potentially launch a large-scale, network wide attack by cascading the traffic from multiple launch points.

A DDoS attack, in which an attacker uses multiple distributed agents to simultaneously mount attacks against a target network node, is a simple but very strong attack that can exhaust not only one system's resources but also network resources. In reality, a large amount of abnormal traffic resulting from a DDoS attack together with a worm virus causes many problems, for example, causes Internet connection failures or slows down affected network nodes, and the damage caused by these problems is becoming more and more serious. In particular, most local area networks (LANs) have a hierarchical network structure such as a tree structure. Thus, if a certain router is paralyzed by an attack, its lower networks also lose connection to the Internet, resulting in communication interruptions. Accordingly, a wide area may be affected by the attack.

Various methods have been suggested to defend against cyber attacks such as DDoS attacks. The methods include firewalls, an intrusion detection system (IDS), an intrusion protection system (IPS), and a DDOS response system.

However, in cyber attacks like DDoS attacks, the attacking traffic penetrating personal computers are in the form of normal packets or service requests from the perspective of the target systems. Thus, it is not easy to detect and control the attacking traffic.

### SUMMARY

It is an objective of the present invention to protect an internal network and normal service use by blocking cyber attacks, such as distributed denial-of-service (DoS) attacks, through traffic analysis and flow-based dynamic access control.

It is another objective of the present invention to block various forms of cyber attacks (including cyber attacks in the forms of normal packets and service requests, such as DDoS attacks) and provide uninterrupted service to existing or normal traffic flows connected to a network even during cyber attacks by performing flow-based access control using any user authentication method, a completely automated public turing test to tell computers and humans apart (CAPTCHA) text input method, or the like and by allowing only traffic flows verified as normal access requests to access the network.

In one general aspect, there is provided a flow-based dynamic access control system for controlling a user's access to an internal communication network through an external communication network. The system includes an access control unit operating in an access control mode in which traffic received from a user is basically blocked, generating state management information of a flow, which is received from the user, based on a specified packet of the flow, and verifying whether access of the flow to the internal communication network is a normal access.

In another aspect, there is provided a flow-based dynamic access control system for controlling a user's access to an internal communication network through an external communication network. The system includes: an access information generation unit operating in an access control mode in which traffic received from a user is basically blocked and generating state management information of a flow, which is received from the user, based on a specified packet of the flow; and an access control determination unit verifying whether access of the flow to the internal communication network is a normal access.

In another aspect, there is provided a flow-based dynamic access control method for controlling a user's access to an internal communication network through an external communication network by using an access control system. The method includes: basically blocking an input flow which corresponds to an access request from a user and generating state management information of the flow by using the access control system of the internal communication network; verifying whether access of the flow to the internal communication network is a normal access; and allowing the flow to access the internal communication network when verifying that the access of the flow to the internal communication network is the normal access and updating the state management information of the flow.

In the verifying of whether the access of a flow to the internal communication network is the normal access, any outbound packet of a flow is regarded as normal access packets to the outside network if there is no special restriction to accessing outside network, and any inbound packet of a flow is regarded as normal access packets to the inside network only when the state management information of the flow is set to an “access allowed state”.

A method and system for protecting an internal network through traffic analysis and flow-based dynamic access control according to the present invention can block various forms of cyber attacks (including cyber attacks in the forms of normal service requests, such as DDoS attacks) and allow normal users to access an internal network without interruption.

Other features and aspects will be apparent from the following detailed description, the drawings, and the claims.

### BRIEF DESCRIPTION OF THE DRAWINGS

FIG. 1 is a diagram illustrating an example entire network structure for protecting an internal network through flow-based dynamic access control;

FIG. 2 is a flowchart illustrating an example data traffic processing process performed by the flow-based dynamic access control system;

FIG. 3 is a flowchart illustrating an example process of the flow-based dynamic access control system; and

FIG. 4 is a diagram illustrating an example network configuration and an example data traffic processing process for preventing cyber attacks on a web server.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The invention is described more fully hereinafter with reference to the accompanying drawings, in which exemplary embodiments of the invention are shown.

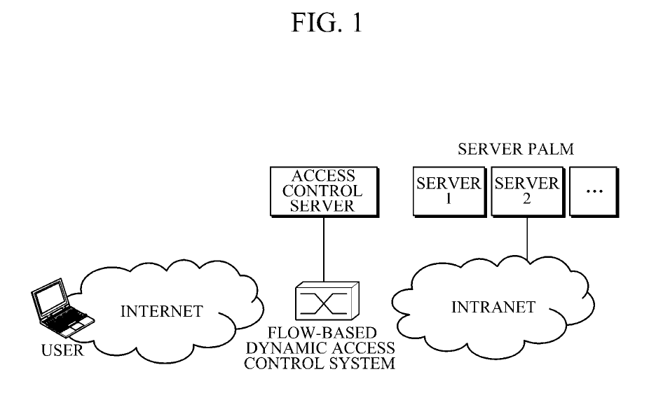

FIG. 1 is a diagram illustrating an example entire network structure for protecting an internal network through flow-based dynamic access control.

Referring to FIG. 1, a flow-based dynamic access control system according to the present invention is located at the boundary between an internal network and an external network or in front of a server palm in order to protect the internal network against cyber attacks and guarantee the quality of normal traffic even during cyber attacks. The flow-based dynamic access control system determines the presence of abnormal traffic by analyzing all or certain amount of input traffic from an external user.

The decision of whether the all traffic or certain amount of traffic is analyzed will be controlled based on an operator's manual configuration or an autonomous request from an external traffic analysis system.

When an access control is statically configured by an operator regardless of the presence of the abnormal traffic or when the access control is requested by an external traffic analysis system, the flow-based dynamic access control system operates in an access control mode. In the access control mode, the flow-based dynamic access control system checks, on a flow-by-flow basis, with an access control server linked therewith whether the access of input traffic to the internal network is allowed or not, and permits only the allowed traffic to be delivered to the internal network, thereby protecting the internal system from cyber attacks.

A flow typically consists of 5-tuple information, that is, an IP source address, an IP destination address, protocol numbers, source transport layer port information, and destination transport port information. However, other header information of an IP packet can be added to the 5-tuple information or some fields can be removed from the 5-tuple information, according to a setting by the operator or characteristics of an application. This implies that a flow can consist of only IP source address in an extreme case.

When in a normal mode, the flow-based dynamic access control system allows all traffic to access the internal network. When in the access control mode, the flow-based dynamic access control system generates state management information of a flow based on a first packet of the flow and makes the access control server perform the verification or authentication of the flow.

The state management information of the flow basically indicates that the flow has not yet been allowed to access the internal network. Thus, subsequent packets from a corresponding user or the flow are discarded until an access control response message indicating that the network access of the flow is allowed is received from the access control server and thus the state management information of the flow is updated accordingly.

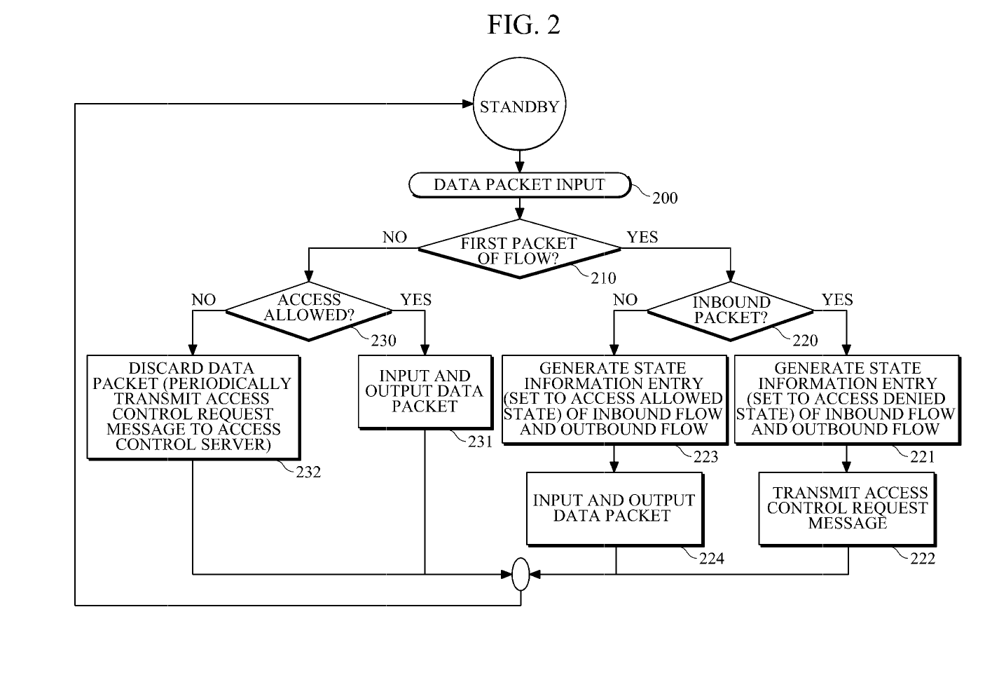

FIG. 2 is a flowchart illustrating an example data traffic processing process performed by the flow-based dynamic access control system.

Referring to FIG. 2, when a data packet of a flow is input (200), it is determined whether the input data packet is the first packet of the flow (210). When the input data packet is the first packet of the flow, the dynamic access control system generates the state management information of the flow by configuring information about the flow and stores the generated state management information according to the verification or authentication result of the flow. Accordingly, subsequent packets of the same flow are processed based on the stored state management information of the flow.

When the input data packet, which is the first packet, is an inbound (incoming) packet (220), the state management information of the flow and that of a pairing outbound (outgoing) flow are basically set to an “access denied state” (221). In a state where the state management information of the flow is set to the “access denied state”, an access control request message is transmitted to the access control server to make the access control server authenticate a user who sent the data packet (222).

When the input data packet, which is the first packet, is not the inbound packet (220), the state management information of the inbound flow and that of the pairing outbound flow are set to an “access allowed state” (223).

In this case, the user's access to the internal network is allowed, and the data packet is input to or output from the internal network (224).

Setting of both the state management information of the inbound flow and that of the outbound flow as described above is based on the assumption that internal traffic is reliable and that a response to the internal traffic is also reliable.

When the input data packet is not the first packet (210), it is determined whether to allow the access of the input data packet to the internal network, based on the state management information of the flow of the input data packet (230). When the input data packet is allowed to access the internal network, the user's access to the internal network is allowed, and therefore both of the input to and output from the internal network are allowed (231). When the input data packet is not allowed to access the internal network, it is discarded (232). However, in this case, to make it possible to update the state management information of the flow later on to the “access allowed state”, the access control request message may be periodically transmitted to the access control server so that the access control server authenticates the user later.

To manage the state management information of each flow, the flow-based dynamic access control system generates an entry for each flow based on various fields of an IP header. Here, the various fields of the IP header are extracted from input traffic according to a choice of an operator or an external traffic analysis system or characteristics of each application. In some cases, the flow-based dynamic access control system may generate an entry for flows in opposite directions, so that the state management information of a flow is applied not only to corresponding traffic but also to traffic in the opposite direction of the corresponding traffic.

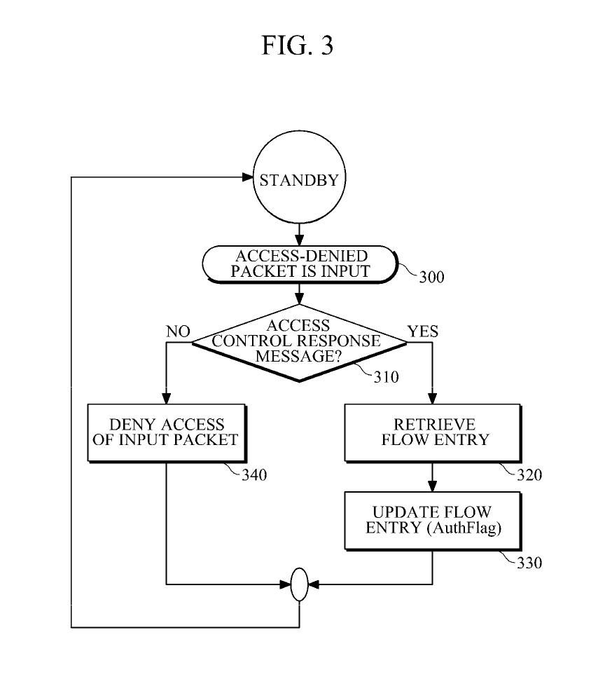

FIG. 3 is a flowchart illustrating an example process of the flow-based dynamic access control system.

Referring to FIG. 3, when a packet whose access to the internal network is restricted (denied) is input to the system (300), the access control server authenticates a user who sent the packet and generates an access control response message based on the authentication result. When the access control response message indicating that the access of the input packet to the internal network is allowed is received from the access control server (310), the state management information of a flow corresponding to the input packet is retrieved (320), and an entry corresponding to the state management information of the flow is updated to the “access allowed state” (330).

When the access control response message is not received, the access of the input packet remains restricted (340).

Verification or authentication of a flow can be performed using various methods, ranging from a strict authentication method, which requires an authentication certificate according to a security level of the access control system or a choice of an operator, to an authentication certificate verification system, a completely automated public turing test to tell computers and humans apart (CAPTCHA) text input and confirmation system, and a one-time password server which are used to determine whether the flow is a service request automatically generated by a computer program.

That is, the access control server or function may perform dynamic access control in cooperation with an authentication system linked therewith, such as the authentication certificate verification system, the CAPTCHA text input and confirmation system, or the one-time password server used to determine whether a flow is a service request automatically generated by a computer program or is a normal service request made by a human.

When the access control server determines that an input flow is a legitimate flow, it sends an access permit command to the flow-based dynamic access control system, so that the flow-based dynamic access control system allows the access of the flow to the internal network.

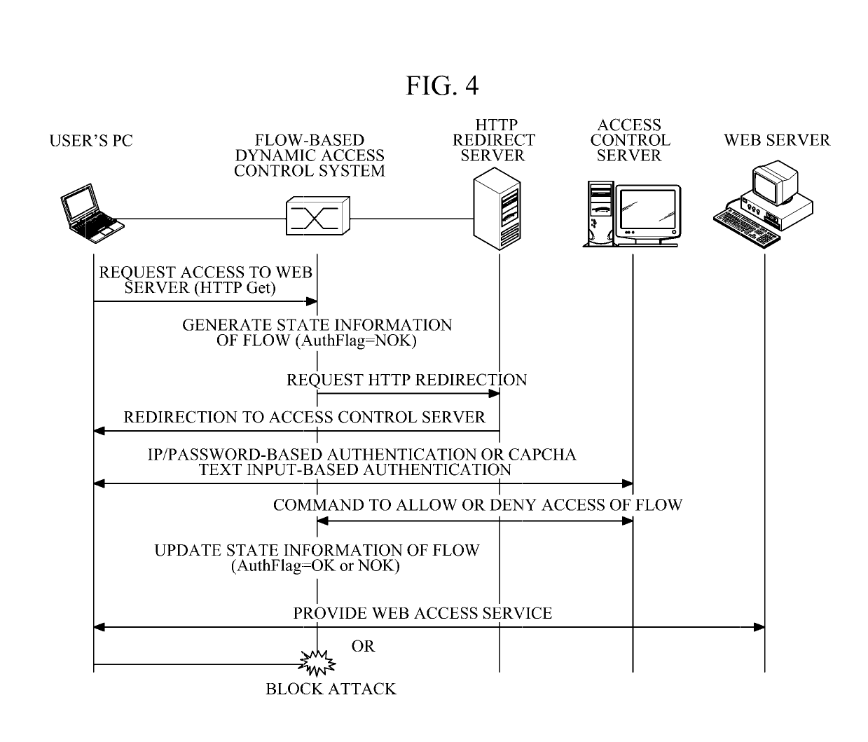

FIG. 4 is a diagram illustrating an example network configuration and an example data traffic processing process for preventing cyber attacks on a web server. The example data traffic processing process is an example of a method of protecting a web server on an internal network from cyber attacks and can be implemented in various forms by using the above-described processes of FIGS. 2 and 3.

Referring to FIG. 4, a flow-based dynamic access control system is linked with a web redirect server. In cooperation with the web redirect server linked therewith, the flow-based dynamic access control system generates the state management information of each flow of web traffic based on a first packet of the flow. Then, the web redirect server redirects the first packet sent by a user to an access control server, such as a CAPTCHA text server or an ID/password authentication server, so that the access control server authenticates the first packet. The access control server sends the authentication result to the flow-based dynamic access control system. Accordingly, the flow-based access control system updates an entry of a corresponding flow, thereby allowing or denying the access of other packets of the corresponding flow to the internal network.

An aspect of the present invention can be implemented as computer readable codes in a computer readable record medium. Codes and code segments constituting the computer program can be easily inferred by a skilled computer programmer in the art. The computer readable record medium includes all types of record media in which computer readable data are stored. Examples of the computer readable record medium include a ROM, a RAM, a CD-ROM, a magnetic tape, a floppy disk, and an optical data storage. In addition, the computer readable record medium may be distributed to computer systems over a network, in which computer readable codes may be stored and executed in a distributed manner.

While this invention has been particularly shown and described with reference to an embodiment thereof, it will be understood by those skilled in the art that various changes in form and details may be made therein without departing from the spirit and scope of the invention as is defined by the appended claims. Therefore, it is to be understood that the present invention is not limited to the embodiment described above, but encompasses any and all embodiments within the scope of the following claims.

What is claimed is:

1. A flow-based dynamic access control system for controlling a user's access to an internal communication network through an external communication network, the system comprising an access control unit generating state management information of a flow, which is received from a user, based on a specified packet of the flow and verifying whether access of the flow to the internal communication network is a normal access or not.

2. A flow-based dynamic access control system for controlling a user's access to an internal communication network through an external communication network, the system comprising:
an access information generation unit operating in an access control mode in which traffic received from a user is basically blocked and generating state management information of a flow, which is received from the user, based on a specified packet of the flow; and
an access control determination unit verifying whether access of the flow to the internal communication network is a normal access or not.

3. The system of claim 1, wherein the access control unit operates in an access control mode in which the traffic received from the user is basically blocked and, when in the access control mode, sets the state management information of the flow such that the access of the flow to the internal communication network is denied.

4. The system of claim 1, wherein when verifying that the access of the flow is the normal access, the access control unit operates in a normal mode in which the access of the flow to the internal communication network is allowed and updates the state management information of the flow such that the access of the flow to the internal communication network is allowed.

5. The system of claim 1, wherein the access control unit verifies whether the access of the flow to the internal communication network is the normal access or not by analyzing input traffic from the user.

6. The system of claim 5, wherein the analysis of all input traffic is optional, and only a certain amount of traffic can be analyzed.

7. The system of claim 5, wherein the analysis of input traffic is optional and is conducted according to a security level or a choice of an operator of the internal communication.

8. The system of claim 1, wherein when the flow received from the user is a response to traffic transmitted from the internal communication network, the access control unit operates in the normal mode to allow the flow to access the internal communication network.

9. The system of claim 2, wherein after generating the state management information of the flow which is set to an “access denied state” corresponding to the access control mode, the access information generation unit transmits an access control request message to check whether the state management information of the flow has been updated.

10. The system of claim 9, wherein when verifying that the access of the flow to the internal communication network is a normal access, the access control determination unit transmits an access control response message to the access information generating unit so as to inform that the access of the flow is the normal access, and the access control unit, which receives the access control response message, operates in the normal mode to allow the flow to access the internal communication network and updates the state management information of the flow to an “access allowed state” corresponding to the normal mode.

11. A flow-based dynamic access control method for controlling a user's access to an internal communication network through an external communication network by using an access control system, the method comprising:
basically blocking an input flow which corresponds to an access request from a user and generating state management information of the flow by using the access control system for the internal communication network;
verifying whether access of the flow to the internal communication network is a normal access by using the access control system; and
allowing the flow to access the internal communication network when verifying that the access of the flow to the internal communication network is the normal access and updating the state management information of the flow by using the access control system.

12. The method of claim 11, wherein in the verifying of whether the access of a flow to the internal communication network is the normal access, any outbound packet of a flow is regarded as normal access packets to the outside network if there is no special restriction to accessing outside network, and any inbound packet of a flow is regarded as normal access packets to the inside network only when the state management information of the flow is set to an “access allowed state”.
